(19) United States
(12) Patent Application Publication
(10) Pub. No.: US 2014/0083073 A1
(43) Pub. Date: Mar. 27, 2014

(54) Corn Stalk Harvester

(71) Applicant: Arthur Charles Doerscher, SR., (US)

(72) Inventor: Arthur Charles Doerscher, SR., Niles, MI (US)

(73) Assignee: Arthur Charles Doerscher, SR., Niles, MI (US)

(21) Appl. No.: 14/011,721

(22) Filed: Aug. 27, 2013

Related U.S. Application Data
(60) Provisional application No. 61/743,052, filed on Aug. 27, 2012.

(51) Int. Cl. A01D 47/00

(52) U.S. Cl. CPC A01D 47/00
USPC 56/56

(57) ABSTRACT

An apparatus for the harvesting and collecting of plant materials from the tops of the plants, such as a corn plant, or other types of crops, above the ear(s), either before, during or after pollination, sweet corn harvesting time or at the black layer, while the stalk is still alive, and has most of its moisture, or at any advantageous time in the growing cycle and collect such plant materials for livestock feed, fuels, sugars or other nutrients, and or for any other useful purpose.

### FIELD OF INVENTION

An apparatus for the harvesting of multiple crops from, a corn stalk, such as, the top portion of the stalks and leaves, the tassels which contain pollen and other nutrients useful for a variety of products, for producing seed corn, or sweet corn, or cash grain crop, the remaining husks and cobs, the lower portion of the stalk to be collected later and used for any useful purpose or left over in the field to be used as livestock feed, fertilizer, and or humus.

### BACKGROUND OF INVENTION

In corn, the stalk(s) must grow large enough to produce and support the ear(s), while producing a pollen fertilization tassel on top, which when properly mature, drops its pollen on to the silk that is located at the end of the corn ear, and the pollen then fertilizes the kernels with in the ear(s). The corn plant can be manipulated to produce certain types of the corn kernels that contain better characteristics for that which it is intended by introducing foreign pollen to the ear silk, also, there are times when trimming the plant foliage is advantageous for a variety of reasons, for example, if the kernels are for specific types of corn, such as seed, sweet corn or grain. When seed corn is desired, male and female plants are planted in separate rows and a standard practice is, before the tassels drops its pollen, the tops of the corn plants are removed, in certain rows, where virtually every stalk of one sex must have its tassel(s) removed by cutting, or with some varieties, the top portion can be harmlessly pulled out, these are dropped on the ground thus preventing pollination of any ears so that they can be pollinated by the rows that have their pollen left intact. When pollination occurs, then the pollen(s) changes the characteristics of the corn kernels in relationship to the seeds. The remaining rows have their tops with their pollen left intact and these rows, with their pollen, fertilize all the ears in the field. The amounts of proteins, carbohydrates, and starches in this kind of grain are not as great an issue, because what matters most is that it be used for seed. It must be noted at this point that these tops are dropped on the ground and wasted.

At least another time trimming off the tops of the corn plant would be advantageous is after pollination and allowing furthering maturing of the whole plant, the tops would be collected then, or leave the tops and allow the ears and kernels to mature out to maximum sweet corn yields, then, just before harvesting of the sweet corn, removed, collect and utilize the tops, giving at least a multiple crop from the corn stalk(s). The ears however would be saved for, such as, but not limited to, human consumption, where the value of the sweet corn ear(s) would be higher than dried corn, thus making the corn crop(s) more valuable.

At least another time the corn plants can be trimmed is around the black layer time which is another aspect entirely and pertains to a cash grain crop of fully mature corn grain. The black layer occurs on the corn kernel itself, where it attaches to the cob, this point of the kernel turns black, this occurs at the end of the grain growing cycle showing that the part of the grain kernel that transfers nutrients from the cob to the grain kernel is now dead, and no further growth can occurs. At the black layer, the corn stalk has done its job, and is no longer needed, except to hold the corn ear up to be harvested, at this time the stalk is still totally alive and contains essentially all its nutrients. Collecting the tops just above the ear, at these time(s) would capture essentially all the proteins, starches and food values of the stalk and also facilitate a faster drying out of the grain because the stalk has been cut open and at least some of the plants stalks has been removed which would not need to dehydrate.

After its initial growth cycle, then the corn plant goes into another cycle, that of preparing the crop(s), what ever it is at this point, to mature out for harvesting. If left alone after maturity, the plant begins to slowly shed its moisture and the stalk and leaves die, the ear husk, dry out, loosen, and the ear drops over and the kernels dehydrate, till the moisture level is deemed suitable for harvesting.

At least another time the corn plants can be trimmed is at the end if its dehydration time, at a full grain cash crop, then split the crop, some for dry matter for feed or other purposes, then harvest the grain and leave the lower portions of the stalks with the husks and the cobs for livestock feed, ground cover or to be turned into the soil for fertilizer and or humus.

There is a need for an apparatus that will cut and collect these plant materials while they are still alive so that they can be utilized in the most advantageous way and not wasted. These plant materials can and should be utilize for useful purposes.

When seed corn is desired, there would be opening(s) in the cutting and collecting aspect of the machine where certain row(s) would not be cut, the machine would be adjustable as to height of cut and also which rows would be cut or uncut, the rows that are left would pollinate the rows where the tassels have been removed.

The tassel pollen(s) contain certain characteristics of the corn varieties that can be passed on to other varieties if cross pollination occurs, there fore, the collection, with or without chopping of these tassel(s) can be another valuable asset to the crop producer(s) for this or other purposes such as food or fuel etc. The corn stalk harvester, when in the de-tasseling mode, would then cut off or pull out and collect the top portion of the stalks with the tassels.

The corn stalk harvester, in the sweet corn or black layer mode would have no openings in the cutting and collecting aspect of the machine, where all the rows would be cut, and collected all at the same time.

In order to maximize profits in crops, there are various varieties that have a predetermined growth cycle in the form of days from planting till harvest. This is because crops are planted all over the world and in areas where there is a wide range in the seasons, longer in the south, shorter in the northern regions.

There fore there are varieties that are bred to mature out in a predetermined amount of days, so when that time is reached, this is a good indicator to decide what to do with the plant, either to begin to utilize various parts of the plant or allow the plant to go through its entire life cycle. The corn stalk harvester would allow a crop producer to manage the crops as never before.

It should be noted, that the corn stalk, is a resource pulling entity, where the roots, stem, and leaves, pull nutrients from the ambient environment and funnel the collected energy into the corn kernel. If only one of the plant leaves is removed prior to maturity time, such as some aspects of seed corn or sweet corn or grain corn black layer, yield will be lost. So it is critical that the corn stalk not be disturbed before the proper time occurs. However, just before, at or after the harvesting of sweet corn or, the black layer, there is a window of opportunity to collect these nutrients and preserve them for a multitude of purposes such as silage. Other harvesting machines U.S. Pat. Nos. 4,989,399, 4,890,447, 4,250,697, 3,827,219, 3,736,731, 3,724,184, 3,717,982, remove the tassel and drop it on the ground, and U.S. Pat. No. 7,540,129 mention a variable height machine with sensors to collect targeted types of silage, however these don't address the removal and collecting of the parts of the plant above the ear, and splitting the harvest and leaving the lower portions of the stalk with the ears for another crop to harvest such as at sweet corn time or at the black layer or cutting the plant open to facilitate an earlier harvest by expediting the drying out of the grain for another cash crop such as grain. These harvest the whole plant however these have no provision to split the harvest of the different parts of the corn plant or similar crops and utilize these in the same or different times or ways, such as, but not limited to, the collecting of the tops of the stalks above the ear(s) and process these for food or other purposes.

Studies have shown that a measurable percentage of loss will occur for every day that the grain is left in the field and not harvested when the moisture in the corn kernel reaches around 40 percent. Such loss is due to weather, animals traveling through the fields, or weak corn stalks, etc. so the earlier the grain can be collected the better the yield.

According to the university studies in the, USA, the top portion of the corn stalk above the ears contains an average of 7% protein with an average of 50%-55% amount of energy that can be utilized for TDN, or total digestible nutrients which, if turned into good quality silage, is equal to good quality alfalfa hay which is compatible for at least feed of livestock such as cattle. The tops of the corn stalks would produce at least 90% of the feed requirements for non lactating cattle and can supply most of their daily dietary needs with only a small amount of supplements needing to be added, and there are a whole host of other products that can be derived from the green stalks and leaves. According to university studies in the, USA, collecting the tops of the corn plants, at these times, would produce, on the average, slightly over 2000 to 2500 lbs of plant materials per acre.

Silage is where parts or all of the corn plant are chopped into small pieces and then sealed into a container where the initial fermenting process produces carbon dioxide, the carbon dioxide kills off the initial bacteria, and if the product is keep sealed, such as in a silo, or sealed bag, the product pickles itself, thus preserving itself indefinitely.

### SUMMARY

The primary objective of this invention is to produce a machine that allows the crop producer to separate the crop in such a way that they can harvest a new crop by cutting, removing and collecting the tops of the plants above the ears, such as corn and utilize these for profit while still producing seed or other corn, as well as assist the travel of the free born pollen traveling through the air to reach the silk on the ears to pollinate the kernels of the plants that had their tassels removed, and collecting the plant characteristics in the pollen, also to produce silage around the de-tasseling time, the sweet corn time, or the black layer or to re-coupe some of the losses when an early frost occurs, shorting the dehydration time by cutting the plant open straight across or on the bias, maximizing the opening for dehydration where it can shed its moisture and eliminate the top portion of the plant so that it will not slow down the drying process and also facilitate an earlier harvest while grain prices may be higher and the crop producer, with an earlier harvest can take advantage of such prices. The height of cut above the ear(s) would be adjustable taking all factors into consideration of the ambient environment, and the particular characteristics of the species for which it is intended, in order to maximize the yield and to turn such collected plant materials into any useful product for an additional cash crop such as high quality feed or fuels.

Or in another embodiment of this invention, the harvester would be coupled with other implements, such as but not limited to, applying herbicides, pesticides, fertilizers, electric shocks, which has been said to improve plant growths, thus making the traversing of the fields more profitable and or off setting the costs involved with such farming practices and there would or would not be sensor(s) to sense the location of the corn ear, and cut just above or at different heights in relationship to the ears as well as to moisture content or the time of year or growth cycles and remove the top portion of the stalk, by cuttings or plucking, making multiple crops from the single plant stalks and maximizing the utilization of available moisture and nutrients in a way heretofore impossible.

There are many variations that are not mentioned here that would still fall into the category and scope of this invention so the descriptions here mentioned do not totally limit the intent of the invention.

### BRIEF DESCRIPTION OF THE PREFERRED EMBODIMENT

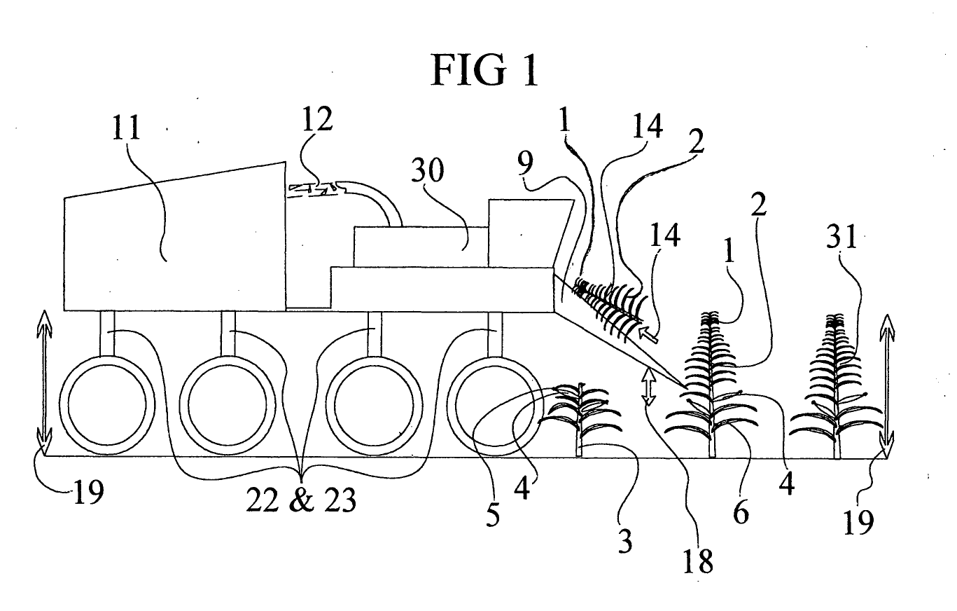

FIG. 1, shows a harvester in its entirety for harvesting the tops of the corn stalks just above the corn ear, however, some rows will not be cut or trimmed, so the main body must be lifted over these, those that are cut, the tops being collected, chopped, or not chopped and deposited into a wagon that is being pulled by the harvester or by another vehicle, to be utilized for any useful purpose;

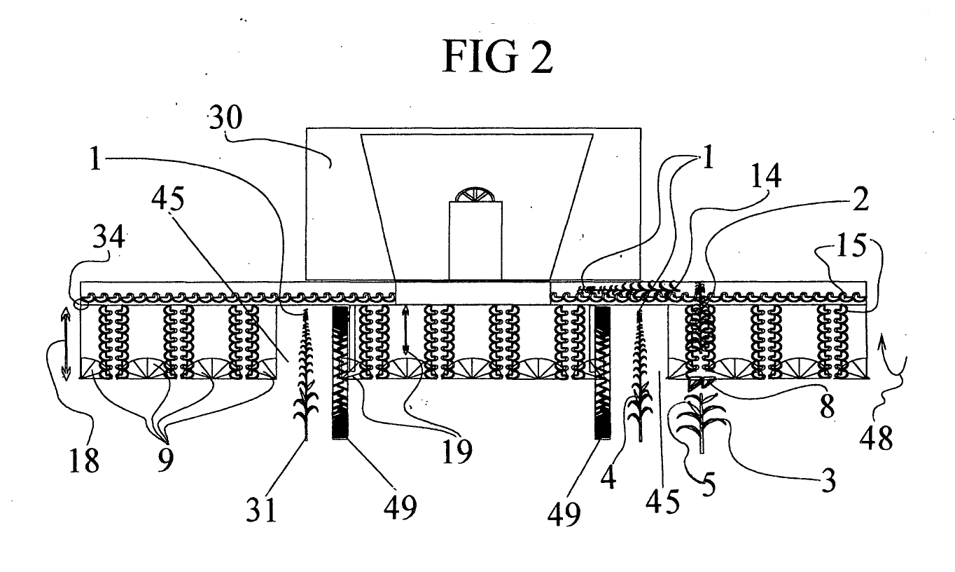

FIG. 2, is a frontal view of the “corn stalk harvester”, on tall wheels with opening to allow uncut rows of corn with its tassel to pass through the harvester for “de-tassling” of the other rows having their tops cut off at any height above the ears and the tops being lifted and conveyed to the chopper(s);

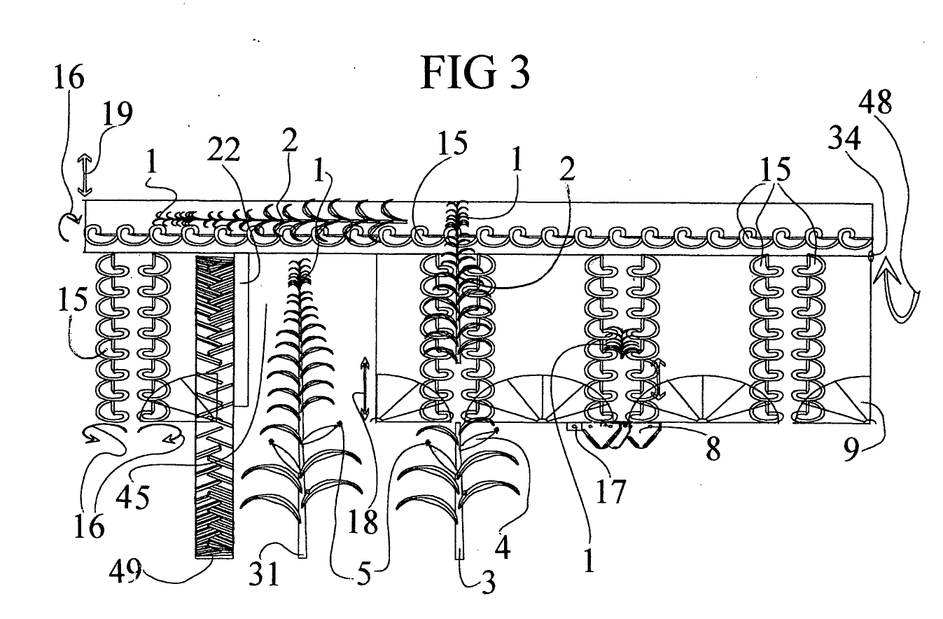

FIG. 3, is an enlarged sectional view of the harvester in more detail showing the opening(s) for uncut row to pass through the harvester and the other rows having their tops cut off at any height above the ears and these tops being lifted and conveyed to the chopper(s) by the augurs, or other means, so they can be processed in any way for any useful purpose;

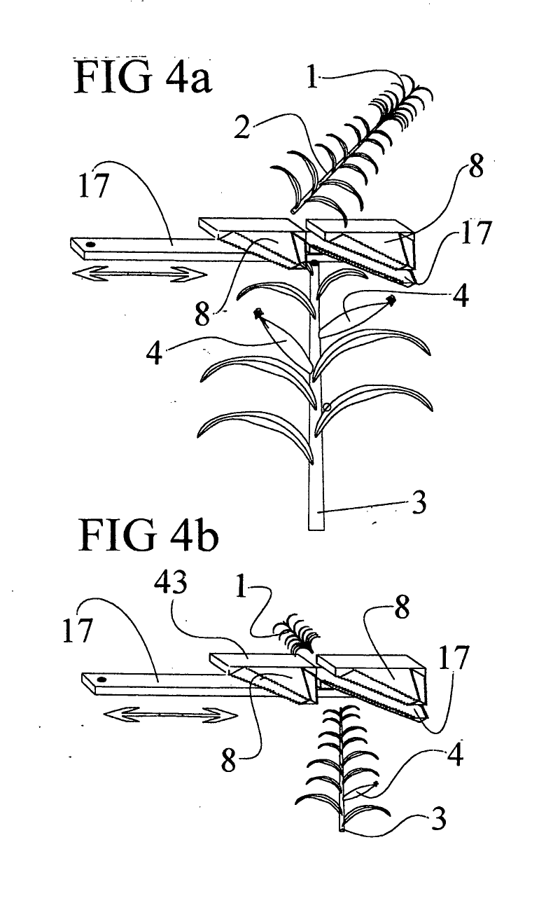

FIG. 4a, is an exaggerated view showing at least one way of the cutting means to remove the tops of the corn stalks at any height above the ears while leaving the lower portion with its ears in the ground for later processing;

FIG. 4b shows a cutting means removing just the upper most portions of the tops for collecting and how at least one member would move back and forth to sever the stalk;

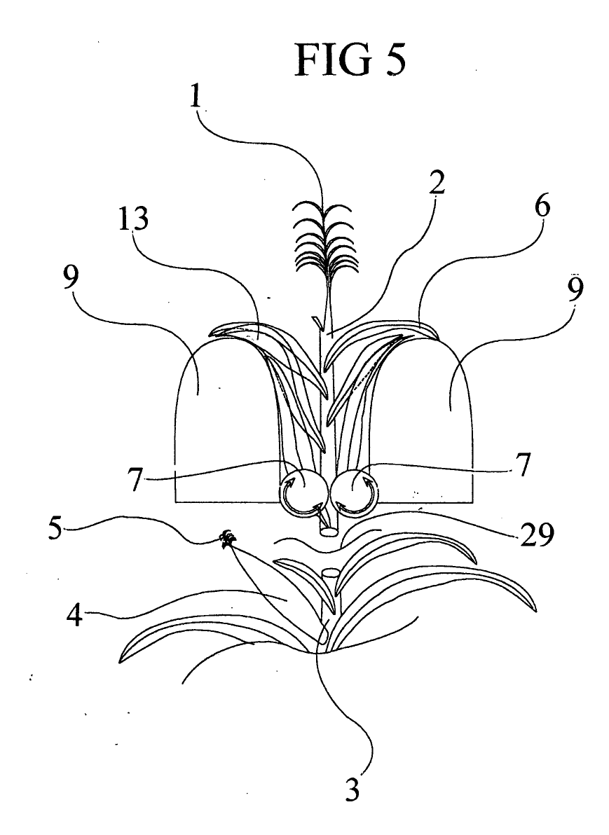

FIG. 5, shows the lifting and dividing cones funneling the stalk into the plucking rollers and severing the two parts of the plant just above the ears so the tops can be processed for any useful purpose;

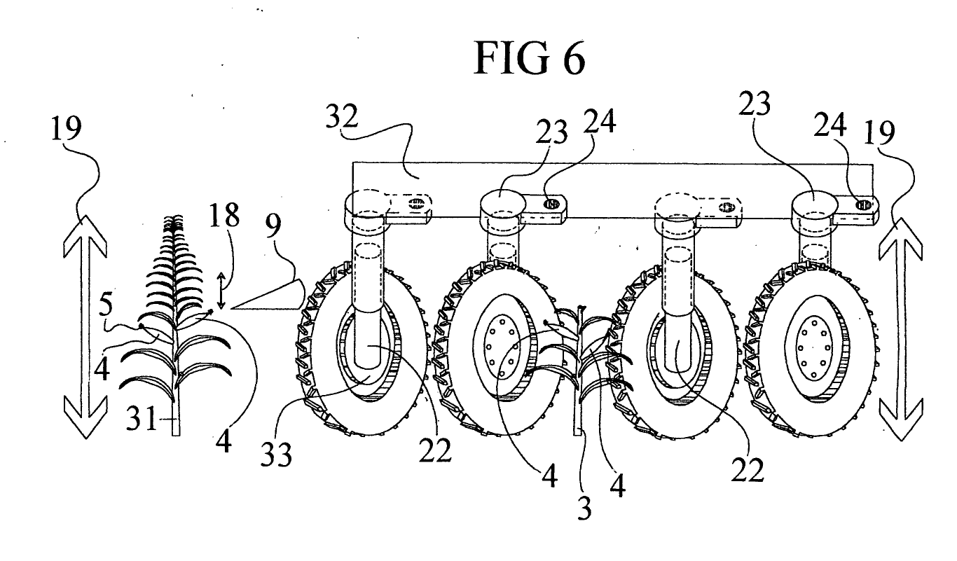

FIG. 6, shows the harvester carriage and the lifting, driving and steering means for the carriage to raise it just above the cut off stalks or over an “uncut” row of stalks, the lifting means being located on the wheels that have a thin width so as to be able to traverse the field between the rows and how the lifting means would also serve as a steering means and how the lifting and dividing cones with its cutting means would be height adjustable;

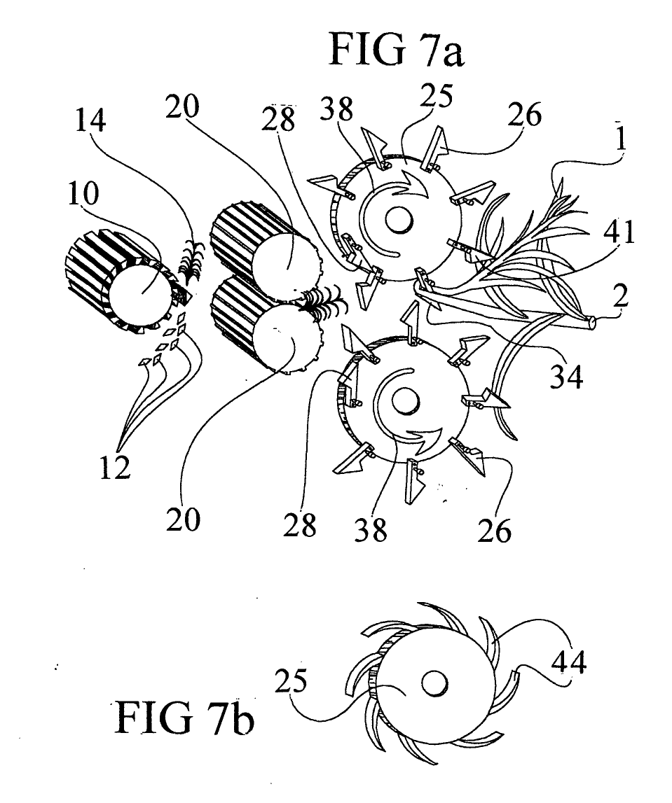

FIG. 7a, shows one way that the stalks would be hooked and pulled into the feeder rollers by the pick up fingers and the fingers would move out of the way to allow the pick up wheels, that they are mounted on, to be closer to the feeder rollers, and then put the stalks into the chopper(s) and one way that the collected plant matter could be processed for any useful purpose;

FIG. 7b shows another option of how the fingers would be shaped to convey the plant matter into the chopping or processing means;

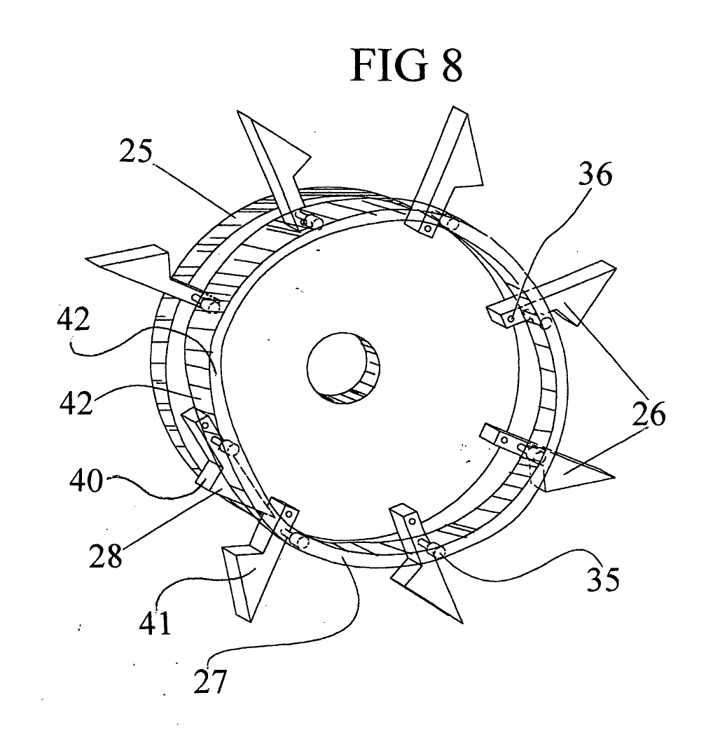

FIG. 8, is a view of one way that the plant materials would be introduced into the processing means, such as, the pick up wheels with its pick up fingers and how the fingers could move out of the way of the feeder rollers by the use of an oblong ring that the pick up finger posts would travel in, and how the indent of the oblong ring would move the pick up fingers that are mounted on hinges; out of the way when they are close to the feeder rollers and at the right time, release the plant stalks and these allow the pick up wheels to be closer to the feeder rollers;

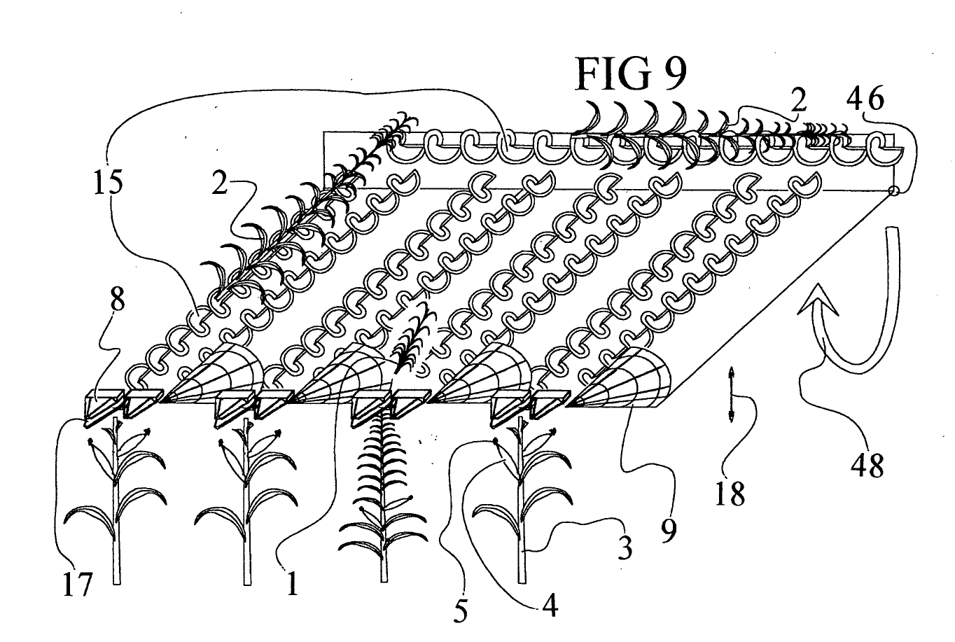

FIG. 9, shows the cutters severing the tops of the corn stalk(s) off the lower portion of the corn stalk and one way that the severed top(s) would be lifted and conveyed to the processing means by the use of conveying augurs;

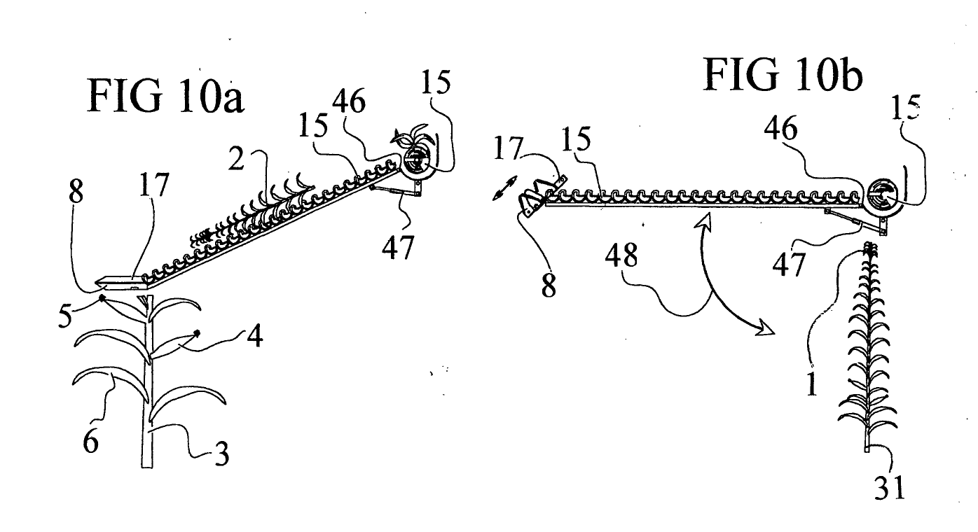

FIG. 10a, is a side view of the height adjustable means for the cutters, while lifting the severed top(s) of the corn stalk up to the conveying augur(s), and the height adjustable means, such as a hydraulic cylinder in conjunction with a hinge point would adjust the height of the cut and here it has been lowered to a position just above the ears;

FIG. 10b shows the height adjustable means with the cutters having been lifted up above the uncut rows of corn so the harvester can traverse the field and not harm the “uncut” stalks, such as turning around at the ends of the rows or field.

### DETAILED DESCRIPTION OF THE PREFERRED EMBODIMENT

FIG. 1 shows a harvester, 30, in its entirety with the body raised high, 19, enough to clear the tops of uncut stalks, 31, by the hydraulic lifting and steering cylinders, 22 & 23, to accommodate different heights of corn stalks, 31, and “corn ears”, 4, with raising or lowering the lifting and dividing cones, 9, and the cutters, 18, lowered to just above the tops of the corn ears, 4, with the machine cutting off the top portion of the corn stalk, 2, with its tassel, 1, above the ears, 4, lifting, 14, the “top portion of the corn stalk, 2, and it being fed into the feeder rollers, (not shown), and then into the chopper, (not shown), these having been chopped and the silage, 12, being deposited into a wagon, 11, traveling down rows of corn, 31, leaving the lower portion of the corn stalk, 3, with its “corn ears”, 4, with its silk, 5;

FIG. 2, is a frontal view of a “corn stalk harvester”, 30, on tall tires, 49, with the lifting and dividing cones, 9, funneling the corn stalks into the cutters, 8, and the top portion of the corn stalk, 2, being lifted up by the augur(s), 15, to the top augur, 15, and being taken to the choppers, (not shown), where as when there is a de-tasseling operation, there would need to be certain rows of stalks that would be uncut, 31, with opening in the front of the machine, 45, so as to leave the tassels, 1, to pollinate the other rows of corn leaving the lower portion of the stalks, 3, with its ears, 4, with its silk, 5, the cutter(s) height adjustable, 18, that swings up, 48, and the body of the machine height adjustable, 19;

FIG. 3, is an enlarged frontal view of the harvester with tall wheels, 49 passing over an “uncut” corn stalk, 31, allowing the “uncut” stalk with its tassel, 1, to pass through an opening(s), 45, the lower portion of the corn stalk, 3, with the ears, 4, being left on the stalks with the top portion of the corn stalk, 2, being cut off the lower portion of the corn stalk, 3, by the cutters, 8, with the lower part of the cutter moving back and forth, 17, to accomplish the cut, where as the lifting and dividing cones, 9, are funneling the stalks to the cutters, 17 & 8, and the top portion of the stalks, 2, is being lifted up by the rotation, 16, of the augur(s), 15, and then to the choppers, (not shown), and the harvester body, can be raised or lowered, 19 by a lifting means, such as hydraulic cylinders, 22, and the cutters, 17 & 8, is also raised or lowered, 18, and 48, as needed, to remove any part of the corn stalk, even just the tassel, 1 at any time in the growth cycle for any advantageous purpose;

FIG. 4a, is an enlarged view of at least one type of cutter(s) with the top portion being stationary, 8, with the lower portion mounted on a slide bar that moves back and forth, 17, to accomplish the cutting off of the top portion of the corn stalk, 2, with its tassel, 1, from the lower portion of the corn stalk, 3 leaving the ear(s) on the bottom portion of the corn stalk, 3, or in certain cases, the cut would be below the corn ears when some or all of the field would be harvested collecting also the ears with its silk, not shown;

FIG. 4b, is an enlarged view of at least one type of cutter(s) with the top portion being stationary, 8, with the lower portion mounted on a slide bar that moves back and forth, 17, shows the stationary part of the cutters, 43 & 8, and the moveable lower cutter(s), 17, removing mostly only the tassel, 1, from the lower part of the corn stalk, 3, leaving the ear(s), 4, on the bottom portion of the corn stalk, 3,;

FIG. 5, is a rearward view that shows the dividing and lifting cones, 9, lifting the leaves so that all or portions of the leaves, 6, can be cut off collecting as much of the foliage as possible from the top portion of the corn stalk, 2, and the lower portion of the corn stalk, 3, by the cutters, not shown, or the plucking rollers, 7, pinching and pulling the top portion of the corn stalk, 2, up and out of the lower portion of the corn stalk, 3, and the two parts being severed, 29, by the plucking rollers, 7, but leaving the lower portion of the corn stalk, 3, with its ears, 4, with its silk, 5, with the corn stalk, 3, intact in the ground, to be pollinated by the remaining stalks and tassels, not shown and to be turned into seed corn, or to be harvested around the sweet corn time, or left remaining to be a cash grain crop;

FIG. 6 shows part of a harvester carriage, 32, mounted on a lifting means, such as hydraulic or screw lifts, 22, with the drive mechanism, 33, that has a small size to allow for clearance between the rows, with steering cylinders, 23, on at least 2 of the cylinders, with steering links, 24, for the steering mechanisms, not shown, where the harvester carriage, 32 can be raised or lowered, 19, to allow clearance for the complete corn stalk, 31, with the ear(s), 4, and its silk, 5, the lifting and dividing cones, 9, that can be raised or lowered, 18, before the top portion is harvested, or the lower portion of the corn stalk, 3, that is left in the ground with its ear(s), 4, that can facilitate an earlier harvest if the ear(s) are for a grain crop.

FIG. 7a, is an enlarged view showing the top portion of the corn stalk, 2, with its tassel, 1, after it has been cut off the lower section of the corn stalk, not shown and it has been moved to the pick up area and the pick up fingers, 26, grabs the corn stalk, 2, and pulls it, 34, into the feeder rollers, 20, the pick up wheels, 25, rotate, 38, to move the pick up fingers, 26, however when they are near the feeder rollers, 20, the pick up fingers, 26, are moved out of the way, 28, to allow the pick up wheels, 25, to be closer to the feeder rollers, 20, and allow the pick up fingers, 26, to release the top portion of the corn stalk, 2, by the oblong ring, (shown in FIG. 8) and the stalk is moved into the feeder rollers, 20, by the finger behind the first finger, 41, to move the mass, 14, from the feeder rollers, 20, and then into the chopper(s), 10, or directly onto the choppers, with out any feeder rollers, not shown where it is cut into silage, 12;

FIG. 7b shows another way the pick up fingers would be shaped, such as, curved and flexible, 44;

FIG. 8, is an enlarged view of only the respective parts, showing the pick up fingers, 26, is shaped with an off set angle, 40, so that when the fingers are in the forward position, or directly opposite the pick up rollers, they grab the corn stalk (not show), and pulls the stalk into the feeder rollers, not shown. There is a post, 35 on the pick up fingers, 26, the post rides inside the oblong ring, 27, and the oblong ring pushes the fingers, 26, away from the feeder rollers, not shown, by the indent shape of the oblong ring, 42, when the fingers, 26, are close to the feeder rollers, (not shown), they move out of the way by the pressure between the pick up finger post, 35, and the hinge point, 36, that mounts the pick up fingers on to the pick up wheels, 25, and the angle on the fingers, 40, is shaped so that this movement releases the corn stalk matter, not shown, and allows it to be pulled into the feeder rollers, not shown, by the finger behind the first finger, 41, This allows the pick up wheels to be located closer to the feeder rollers.

FIG. 9, is an enlarged frontal view showing the front of a multi row harvester with the lifting cones, 9, and the cutters, 17 & 8, that have cut off either the tassel only, 1, or the top portion of a corn stalk, 2, from the lower portion of a corn stalk, 3, leaving the corn ear(s), 4, intact on the lower portion of the corn stalk, 3, and the cut off top portion of the corn stalk, 2, these being lifted up by a lifting means such as at least one augur, 15, to the top augur, 15, to be moved over to the choppers, (not shown), and how the cutter would be raised or lowered, 18, on the hinge point, 46, and how it would swing up or down, 48, to compensate for different heights in the corn stalk, ears and ground;

FIG. 10a, is a side view of the cutter(s), 17 & 8, having cut off the top portion of the corn stalk, 2, which is being lifted by the augurs, 15, up to the top augur, 15, where as the cutters and augurs are in the down position, by the lifting and lowering means, such as a hydraulic cylinder(s), 47 and the hinge point, 46, to allow for adjusting the height of the cutter(s), 17 & 8, leaving the lower portion of the corn stalk, 3, with its ear(s), 4 with its silk, 5, intact in the ground;

FIG. 10b is a side view of the cutter(s), 17, & 8, with the augers, 15, lifted, 48, by the lifting means, such as a hydraulic cylinder(s), 47, and the hinge point, 46, to allow passage over the “uncut” stalks, 31, with its tassel, 1, so the machine can turn around at the ends of the rows or field, or cut the stalk(s) at any height, even below the corn ear, not shown.

I claim;

1. A adjustable machine that removes some or all of the top portion(s) of a corn plant or similar crop, above the ear or the tops with or without seeds, fruit or pollen, at any advantageous time or purpose in the life of the plant and collect and processes said portion(s) of the removed plant material(s) for any useful and profitable purpose;

2. As per claim one, a machine to take the place of manual labors that de-tassels corn or similar plants or that removes the top portion of a corn plant out of the lower section by cutting or plucking at any height above the ear(s) from such plants, such as, but not limiter to a corn plant, and collecting said portion(s), with or without the tassel, without the tassel coming into contact with the ear silk or collecting said portions for food or fuel by machine or manual labor, for any profitable purpose or market;

3. As per claim one, a machine that would allow a crop producer to harvest multiple crops from a single corn stalk plant or similar crops;

4. As per claim one, a machine that would allow a crop producer greater control over growth and harvest variables;

5. As per claim one, a machine that would allow a crop producer to accomplish more with each pass over the field, such as, but not limited to, cultivate, fertilize, apply herbicide, and trim un-needed excess foliage from the plant(s) and collect such plant materials for food or fuel or for any other profitable market and profit there from;

6. As per claim one, a machine harvester that can be raised or lowered to any height below, or above the ear(s) in order to remove, collect and or harvest any part of a corn plant or similar crop for food or fuel(s) or for any other profitable market;

7. As per claim one, a machine that would allow for more moisture and nutrients to be collect and saved while splitting the harvest of the corn plant, where the portion of the plant above the ear(s) becomes a crop in itself, where the stalk of the plant has done its job, however, it is still alive and capture the nutrients that would other wise be wasted by dehydration in order to produce a high quality food or grain crop, such as corn, with more value by increasing the oils, proteins, starches or reproductive qualities and any other valuable item within the stalk and or kernel;

8. As per claim one, a machine that cuts off or plucks out any portion(s) of a corn plant or similar crop plant that allows for an earlier harvests because the plant is cut open, either perpendicular or on the bias, allowing moisture to escape through said opening, expediting the dehydration of the remaining stalk and grain and by the removal of un-needed leaf and stalk materials on the remaining plant, and this would leave less plant materials that would other wise need to shed its moisture before-harvest;

9. As per claim one, a machine that allows harvesting, collecting, processing and saving “parts” of the corn or similar plants instead of all of the corn plant being harvested at one time for food or fuel, at any time in the growth cycle(s) for any advantageous purpose and at the same time accomplish any other additional processes in the field;

10. As per claim one, a machine that allows for multiple crops to be obtained from a single corn plant at any time in the growth cycle(s) at the same pass over the field or by multiple passes, such as around the de-tasseling time, or around the sweet corn time, or around the black layer time, collect the tops and turn into silage or other uses, and leave the rest of the plant to dry out and be harvested and used for food or returned into the soil for fertilizer and humus, or after the whole plant has dried out and then split the amount of plant materials to be harvested before or after the grain cash crop has been harvested and also at the same time, leave more of the plant materials to assist the ground, either as food, ground cover, fertilizer or humus.
